(19) United States
(12) Patent Application Publication
(10) Pub. No.: US 2026/0333085 A1
(43) Pub. Date: Oct. 22, 2026

(54) SYSTEM AND METHOD FOR COORDINATED OBSERVABILITY DATA GENERATION AND COLLECTION IN DISTRIBUTED SYSTEM

(71) Applicant: Telefonaktiebolaget LM Ericsson (publ), Stockholm (SE)

(72) Inventors: Jinhua FENG, Täby (SE); Nanjangud Chandrasekhara Swamy NARENDRA, Bangalore (IN); Arif AHMED, Kista (SE); Selome Kostentinos TESFATSION, Upplands Väsby (SE)

(73) Assignee: Telefonaktiebolaget LM Ericsson (publ), Stockholm (SE)

(21) Appl. No.: 19/115,726

(22) PCT Filed: Nov. 4, 2022
(86) PCT No.: PCT/IB2022/060646

§ 371 Date: Mar. 26, 2025

(51) Int. Cl. H04W 24/08; H04W 24/10

(52) U.S. Cl. CPC H04W 24/08; H04W 24/10

(57) ABSTRACT

A method performed by an observability management system to collect observability data regarding a distributed system is disclosed. The method includes obtaining observability data requests submitted by a plurality of observability data consumers, generating an observability configuration and an observability data aggregation model based on collating the observability data requests, configuring one or more observability data producers of the distributed system in accordance with the observability configuration to cause the one or more observability data producers to generate observability data, collecting the observability data generated by the one or more observability data producers, aggregating the collected observability data in accordance with the observability data aggregation model to generate an aggregation result for each of the observability data requests, and reporting, to each of the plurality of observability data consumers, the aggregation result for the observability data request submitted by the observability data consumer.

### TECHNICAL FIELD

Embodiments of the invention relate to the field of distributed systems, and more specifically, to generating and collecting observability data in distributed systems.

### BACKGROUND

In mobile networks, and particularly mobile network having cloud native network functions deployed in a distributed cloud environment, being able to generate and collect observability data (e.g., performance measurements, logs, traces, etc.) is critical for being able to provide automated and intelligent network operations such as fault analysis, workload orchestration, and service assurance. Generating and collecting observability data adds non-negligible overhead to the mobile network (e.g., these operations consume computing resources, data storage resources, and/or network resources), and thus may negatively impact the performance of the mobile network. Network functions are being designed to generate various types of observability data and when deployed may generate large amounts of observability data. It can be challenging to efficiently configure the network functions to generate the appropriate scope of observability data to support network operations while introducing minimal overhead.

In some cases, different network operations may need the same or similar observability data generated by the same set of network functions for different purposes. For example, in a mobile network context, both a network optimization service and a network slicing SLA (service level agreement) management service may need performance measurements from a set of network functions. The network optimization service and the network slicing SLA management service may provide different services with different goals but need similar observability data from the same set of network functions for their operations. Typically, the network optimization service aims to improve network efficiency, while the network slicing SLA management service aims to improve the end-user experience. These two observability data consumers may have slightly different requirements in terms of the observability data that they need (e.g., different measurement intervals and/or durations), which requires executing two separate jobs on the set of network functions to generate the observability data.

Different observability data consumers needing the same or similar observability data typically configure the observability data producers to generate observability data separately and also aggregate/process collected observability data separately, particularly when the observability data consumers are operated and/or managed by different entities. This may result in imposing competing (or even conflicting) observability data generation configurations on observability data producers and/or duplicate processing of collected observability data.

### SUMMARY

A method performed by an observability management system to collect observability data regarding a distributed system is disclosed. The method includes obtaining observability data requests submitted by a plurality of observability data consumers, generating an observability configuration and an observability data aggregation model based on collating the observability data requests, configuring one or more observability data producers of the distributed system in accordance with the observability configuration to cause the one or more observability data producers to generate observability data, collecting the observability data generated by the one or more observability data producers, aggregating the collected observability data in accordance with the observability data aggregation model to generate an aggregation result for each of the observability data requests, and reporting, to each of the plurality of observability data consumers, the aggregation result for the observability data request submitted by the observability data consumer.

A non-transitory machine-readable medium is disclosed that comprises computer program code, which when executed by one or more computing devices, causes the one or more computing devices to carry out operations for collecting observability data regarding a distributed system. The operations include obtaining observability data requests submitted by a plurality of observability data consumers, generating an observability configuration and an observability data aggregation model based on collating the observability data requests, configuring one or more observability data producers of the distributed system in accordance with the observability configuration to cause the one or more observability data producers to generate observability data, collecting the observability data generated by the one or more observability data producers, aggregating the collected observability data in accordance with the observability data aggregation model to generate an aggregation result for each of the observability data requests, and reporting, to each of the plurality of observability data consumers, the aggregation result for the observability data request submitted by the observability data consumer.

A computing device to implement an observability management system is disclosed.

The computing device comprises one or more processors and a non-transitory machine-readable storage medium storing computer instructions that, if executed by the one or more processors, causes the computing device to carry out operations for collecting observability data regarding a distributed system. The operations include obtaining observability data requests submitted by a plurality of observability data consumers, generating an observability configuration and an observability data aggregation model based on collating the observability data requests, configuring one or more observability data producers of the distributed system in accordance with the observability configuration to cause the one or more observability data producers to generate observability data, collecting the observability data generated by the one or more observability data producers, aggregating the collected observability data in accordance with the observability data aggregation model to generate an aggregation result for each of the observability data requests, and reporting, to each of the plurality of observability data consumers, the aggregation result for the observability data request submitted by the observability data consumer.

### BRIEF DESCRIPTION OF THE DRAWINGS

The invention may best be understood by referring to the following description and accompanying drawings that are used to illustrate embodiments of the invention. In the drawings:

FIG. 1 is a diagram showing an environment in which observability data can be generated and collected in a coordinated way, according to some embodiments.

FIG. 2 is a flow diagram showing a method for generating and collecting observability data in a coordinated way, according to some embodiments.

FIG. 3 is a diagram showing component interactions for generating and collecting observability data in a coordinated way, according to some embodiments.

FIG. 4 is a diagram showing component interactions for updating an observability configuration and observability data aggregation model, according to some embodiments.

FIG. 5 is a flow diagram of a method for collecting observability data regarding a distributed system, according to some embodiments.

FIG. 6A illustrates connectivity between network devices (NDs) within an exemplary network, as well as three exemplary implementations of the NDs, according to some embodiments of the invention.

FIG. 6B illustrates an exemplary way to implement a special-purpose network device according to some embodiments of the invention.

### DETAILED DESCRIPTION

The following description describes methods and apparatus for generating and collecting observability data regarding a distributed system. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, Different observability data consumers needing the same or similar observability data typically configure the observability data producers to generate observability data separately and also aggregate/process collected observability data separately, particularly when the observability data consumers are operated and/or managed by different entities. This may result in imposing competing (or even conflicting) observability data generation configurations on observability data producers and/or duplicate processing of collected observability data.

As used herein, an observability data consumer is an entity that consumes observability data (e.g., edge service assurance, network and service orchestration, or an analytics system in a mobile network). As used herein, an observability data producer is an entity that produces observability data (e.g., a network function in a mobile network). As used herein, observability data may be any type of data regarding the operations, performance, or state of a component or system. Observability data may take the form of logs, metrics, and/or traces.

Embodiments provide an observability management system that accepts requests for observability data (also referred to as observability data requests) from observability data consumers (which could be associated with different entities/companies/enterprises) and generates an observability data configuration based on collating the observability data requests.

The observability data requests may indicate the observability data being requested at a high level of specificity or a lower level of specificity. If indicated at a high level of specificity (coarse-grained), the observability management system may translate the requirements of the observability data requests into lower-level requirements (finer-grained). The observability data configuration may indicate the configurations that are to be imposed on observability data producers to cause the observability data producers to generate the observability data needed to fulfill the requirements of the observability requests. The observability data configuration may be generated such that the smallest superset of the observability data is generated that fulfills the requirements of the observability data requests. The observability management system may then configure the observability data producers in accordance with the observability data configuration to cause the observability data producers to generate observability data. The observability management system may also generate an observability data aggregation model based on collating the observability data requests. The observability data aggregation model may indicate how to aggregate observability data collected from the observability data producers to fulfill the requirements of the respective observability data requests. The observability management system may collect observability data generated by the observability data producers and aggregate the collected observability data in accordance with the observability data aggregation model to generate aggregation results for the respective observability data requests. The observability management system may then report the aggregation results to the respective observability data consumers that submitted the observability data requests.

An embodiment is a method performed by an observability management system implemented by one or more computing devices to collect observability data regarding a distributed system. The method includes obtaining observability data requests submitted by a plurality of observability data consumers, generating an observability configuration and an observability data aggregation model based on collating the observability data requests, configuring one or more observability data producers of the distributed system in accordance with the observability configuration to cause the one or more observability data producers to generate observability data, collecting the observability data generated by the one or more observability data producers, aggregating the collected observability data in accordance with the observability data aggregation model to generate an aggregation result for each of the observability data requests, and reporting, to each of the plurality of observability data consumers, the aggregation result for the observability data request submitted by the observability data consumer.

With embodiments, an observability management system may consolidate observability data requests submitted by multiple different observability data consumers for observability data related to the same target component and intelligently determine the exact set of observability data that is needed. Also, the observability management system may aggregate collected observability data on behalf of observability data consumers to avoid duplicate processing of the same raw observability data, which would otherwise have to be performed separately by the different observability data consumers. In this regard, the observability management system may act as intermediary between observability data consumers and observability data producers. The observability management system may dynamically configure the observability data producers (while the distributed system is in operation) according to the actual needs of the observability data consumers. Also, the observability management system may take into consideration the observability data generation capabilities of the observability data producers (e.g., as reported by the observability data producers), when generating the observability data configuration to impose on the observability data producers.

In one example use case, the observability management system is used to generate and collect observability data in a mobile network having components deployed in a distributed edge/cloud environment. In such a case, the observability data consumers may be an edge service assurance system, a network and service orchestration system, or a network analytics system. Also, the observability data producers may be network functions deployed in the mobile network. For purposes of illustration, specific embodiments are described herein in the context of a mobile network. However, it should be appreciated that embodiments can be used to generate and collect observability data regarding other types of distributed system.

Embodiments can provide one or more advantages over conventional observability solutions. Embodiments collate observability data requests and configure the observability data producers in a coordinated way such that they only generate the observability data that is needed to fulfill the observability data requests. This may simplify observability data generation and reduce the potential overhead of the observability data producers (e.g., if there are multiple observability data consumers requesting observability data regarding the same target component, the observability management system may configure an observability data producer to execute a single job that generates observability data regarding the target component that can be used to fulfill all of the requests (whereas conventional observability solutions may start a separate job for each request)). Coordinating the configuration of observability data producers and taking into consideration the observability data generation capabilities of the observability data producers may help with avoiding imposing conflicting/competing observability configurations on the observability data producers. The collation of observability data request also allows for performing common observability data aggregation operations in an intermediate layer (e.g., by the observability management system), which avoids duplicating the same processing on the same observability data. This helps save overall resource consumption in a large scale deployment. Aggregation may involve sampling observability data and/or combining observability data to generate an aggregation result that fulfills the requirements of an observability data request. While certain advantages are mentioned above, embodiments may have other advantages that will be apparent to those of ordinary skill in the art in view of the present disclosure.

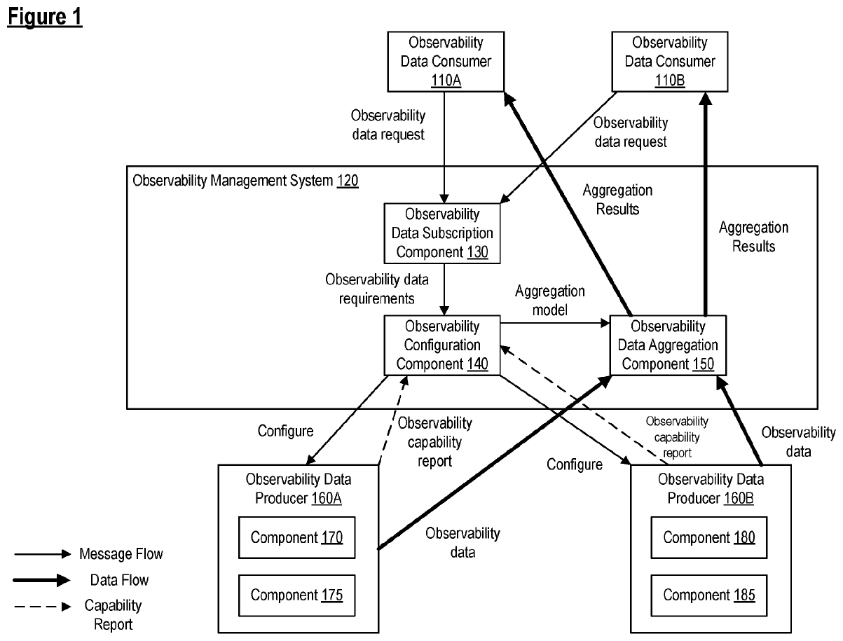

FIG. 1 is a diagram showing an environment in which observability data can be generated and collected in a coordinated way, according to some embodiments.

As shown in the diagram, the environment includes observability data consumers 110A and 110B, observability data producers 160A and 160B, and an observability management system 120. For sake of simplicity of illustration, the diagram shows two observability data consumers 110 and two observability data producers 160. It should be appreciated that the environment may include a different number of observability data consumers 110 and/or observability data producers 160 than shown in the diagram.

Observability data consumers 110 may submit requests for observability data regarding a distributed system to the observability management system 120. In a context where the distributed system is a mobile network, an observability data consumer 110 may be a component of a mobile edge service operation system that needs observability data regarding the mobile network to perform service orchestration, service performance analytics, and/or service assurance. The observability data consumers 110 may submit requests to the observability management system 120 for observability data related to particular components of the distributed system. For example, the observability data consumers 110 may submit requests to the observability management system 120 for observability data related to particular applications or services deployed in the distributed system (e.g., network functions or edge services deployed in a distributed mobile edge). Observability data may be any type of data regarding the operations, performance, or state of a component or system. Observability data may take the form of logs, metrics, and/or traces.

Observability data producers 160 may be configured (e.g., by the observability management system) to generate particular types of observability data (e.g., logs, metrics, and/or traces) with particular granularities (e.g., the specificity/scope of the observability data) and frequencies (e.g., every five minutes). In an embodiment, the observability data producers 160 can be configured dynamically (e.g., while the observability data producers 160 are in operation, without having to perform a restart/reboot). The observability data producers 160 may send the observability data that they generate to the observability management system 120. In an embodiment, the observability data producers 160 send observability capability reports to the observability management system 120 indicating their capabilities with regard to generating observability data (e.g., indicating what types of observability data they are capable of generating, the granularity of observability data they are capable of generating, and/or the frequency at which they can are capable of generating observability data).

The observability management system 120 may manage the generation and collection of observability data in a distributed system. The observability management system 120 may receive observability data requests from observability data consumers 110, generate an observability configuration based on collating the observability data requests, and configure one or more observability data producers 160 in accordance with the observability configuration to cause the one or more observability data producers 160 to generate observability data. The observability configuration may indicate how to configure observability data producers 160 such that they generate the observability data needed to fulfill the requirements of the observability data requests submitted by observability data consumers 110. The observability management system 120 may also generate an observability data aggregation model based on collating the observability requests. The observability data aggregation model may indicate how to aggregate the observability data collected from the observability data producers 160 to fulfill the requirements of the respective observability data requests. Aggregation may involve sampling collected observability data (e.g., extracting every fifth measurement) and/or combining observability data (e.g., summing measurements). The observability management system 120 may collect observability data generated by the observability data producers 160, aggregate, if needed, the collected observability data to generate aggregated results that fulfill the requirements of the respective observability data requests, and report the aggregated results to the respective observability data consumers 110 that submitted those observability data requests.

As shown in the diagram, the observability management system 120 may include various components for managing the generation and collection of observability data such as an observability data subscription component 130, an observability configuration component 140, and an observability data aggregation component 150. An example message flow and data flow involving these components are shown in the diagram. The message flow is shown in the diagram using solid line arrows and the data flow is shown in the diagram using bolded line arrows. The message flow and data flow are described in further detail herein below.

Referring to the message flow, the observability data consumers 110 may send observability data requests to the observability data subscription component 130. An observability data request may specify the observability data that is being requested at a fine-grained level (e.g., as concrete metrics on a specific target component) or at a coarser-grained level (e.g., as general performance indicators of a subsystem). The observability data subscription component 130 may consolidate/summarize the requirements of the observability data requests into observability data requirements (in a format that can be interpreted and used by the observability configuration component 140) and send the observability data requirements to the observability configuration component 140.

The observability configuration component 140 may generate an observability configuration and an observability data aggregation model based on collating the observability data requirements. The observability configuration may indicate how to configure observability data producers 160 such that they generate the observability data needed to fulfill the requirements of the observability data requests submitted by observability data consumers 110. The observability configuration component 140 may configure one or more observability data producers 160 in accordance with the observability configuration to cause the one or more observability data producers 160 to generate observability data. In an embodiment, as shown in the diagram using dashed lines, the observability configuration component 140 receives observability capability reports from observability data producers 160. An observability capability report may indicate what types of observability data the observability data producer is capable of generating and related information. The observability configuration component 140 take the capabilities of the observability data producer 160 into consideration when generating the observability configuration. The observability data aggregation model may indicate how to aggregate observability data collected from the observability data producers 160 to fulfill the requirements of the respective observability data requests. The observability configuration component 140 may send the observability data aggregation model to the observability data aggregation component 150.

Now referring to the data flow, the observability data producers 160 may generate observability data (per the configurations imposed by the observability configuration component 140) and send the generated observability data to the observability data aggregation component 150. The observability data aggregation component 150 may collect and aggregate the observability data generated by the observability data producers 160 in accordance with the observability data aggregation model to generate aggregation results that fulfill the requirements of the respective observability data requests. The observability data aggregation component 150 may then report the aggregation results to the respective observability data consumers 110.

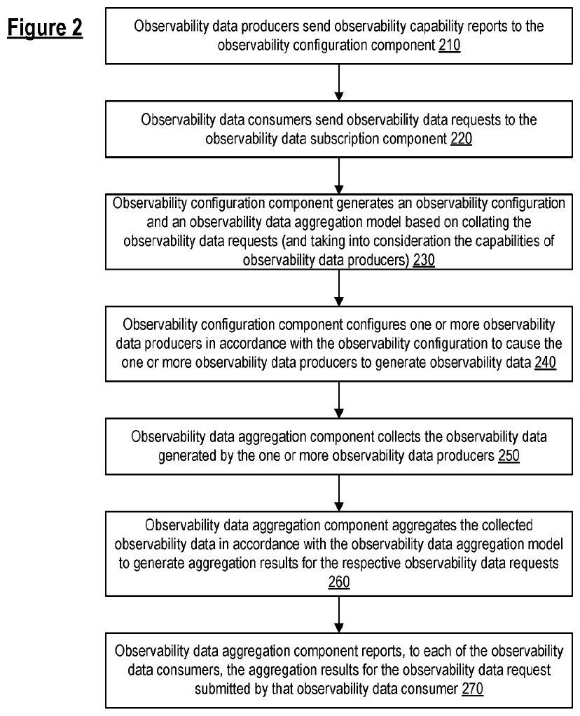

FIG. 2 is a flow diagram showing a method for generating and collecting observability data in a coordinated way, according to some embodiments.

The operations in the flow diagrams will be described with reference to the exemplary embodiments of the other figures. However, it should be understood that the operations of the flow diagrams can be performed by embodiments other than those discussed with reference to the other figures, and embodiments discussed with reference to these other figures can perform operations different than those discussed with reference to the flow diagrams.

At operation 210, observability data producers send observability capability reports to the observability configuration component. An observability capability report may indicate what types of observability data the observability data producer is capable of generating (e.g., logs, metrics, and/or traces), the granularity of observability data the observability data producer is capable of generating (e.g., indicate for each type, the specific observability data items that can be generated (e.g., a list of performance related metrics and/or a list of traces supported by a microservice)), and/or the frequency with which the observability data producer is capable of generating observability data (e.g., indicate that the most frequent interval at which a certain observability data item can be generated is once every minute). In an embodiment, an observability capability report indicates whether the generation of certain observability data types and/or certain data items can be dynamically activated and possibly the mechanism to activate it (e.g., a command that can be used to activate generation of the observability data). If an observability data producer only supports generating static observability data (e.g., the observability data producer cannot be dynamically configured to generate different types of observability data), the observability data producer may send an observability capability report to the observability management system indicating as such. The observability management system may take this information into consideration when generating an observability configuration and/or observability data aggregation model.

As an example, in a Fifth Generation (5G) mobile network context, network functions (which can function as observability data producers) may be capable of generating performance measurements as defined by Third Generation Partnership Project (3GPP) standards (e.g., 3GPP Technical Specification (TS) 28.552). When these network functions are deployed, they may send observability capability reports indicating which performance measurements they are capable of generating to the observability configuration component.

At operation 220, observability data consumers send observability data requests to the observability data subscription component. An observability data request may indicate the particular observability data being requested and related information. An observability data request may specify the observability data that is being requested at a fine-grained level (e.g., specify specific logs, metrics, or traces on target components) or at a coarser-grained level (e.g., specify general performance indicators of a subsystem). In an embodiment, an observability data request indicates the target components (which components to monitor/observe), the types of observability data to collect (e.g., logs, metrics, and/or traces), the observability data collection frequency, the observability data collection duration, and/or observability data reporting instructions (e.g., how the generated observability data should be reported to the observability data consumer (e.g., the observability data request may indicate a service endpoint to which to send the observability data or indicate that the observability management system should provide an endpoint/location from which the observability data consumer can pull the observability data)). It should be noted that it is possible for different observability data consumers to request the same or different sets of observability data on the same target component. As will be described in additional detail herein, the observability management system may be responsible for consolidating and collating the various observability data requests related to the same target component and configuring the observability data producers such that they generate the observability data that is needed to fulfill the requirements of the different observability data requests.

As an example, an observability data request may include the following parameters: targets, measurements, interval, duration, and reporting type. The target parameter may indicate which components are to be observed/monitored. The measurements parameter may indicate the measurements being requested (e.g., which could be standardized or pre-defined measurements such as 5G network related measurements defined by 3GPP standards). The interval parameter may indicate the desired frequency of measurement. The duration parameter may indicate the duration during which to generate the measurements. The reporting type parameter may indicate how/where to report the generated measurements (e.g., send the measurements as a stream or store the measurements in a file).

At operation 230, the observability configuration component generates an observability configuration and an observability data aggregation model based on collating the observability data requests (and possibly taking into consideration the capabilities of the observability data producers as reported by the observability data producers). The observability configuration component may send the observability data aggregation model to the observability data aggregation component.

As an example, the observability configuration component may convert any coarser-grained requirements of an observability data request (specified at a higher level of generality) into more specific requirements. In an example of a mobile network use case, an observability data request may indicate the target components as being a set of network functions, a radio access network (RAN) or a core network deployed in a specific site, or as two endpoints (e.g., if the observability data is related to latency). The observability configuration component may communicate with an OAM (operations, administration, and management) system of the mobile network to derive the more specific network elements accordingly. As another example, the observability data request may indicate that the measurements as being packet delay, packet drop rate, and/or other type of performance indicator (e.g., a KPI (key performance indicator) defined by 3GPP standards). The observability configuration component may map these measurements to concrete observability data items using the capabilities reported by the observability data producers. The observability configuration component may maintain information about the mapping. For example, the observability data request may indicate the measurement using names of measurements or KPIs as defined by 3GPP standards. The observability configuration component may map these measurements to specific measurements that can be generated by network functions (which may function as observability data producers) according to 3GGP standards. In some cases, the measurements indicated by the observability data request may imply that some aggregation on the raw measurements will be involved (e.g., KPIs). In such cases, the observability configuration component may generate an observability data aggregation model indicating how to aggregate the collected measurements to generate the final measurements.

In an embodiment, for each observability data item related to the same target component, the observability configuration component may maintain a list of the observability data consumers that have requested it and the corresponding frequencies and/or durations. For each data item, the observability configuration component may determine the appropriate frequency with which to generate the observability data item and the duration for which to generate the observability data item. That is, the observability configuration component may collate the frequencies and durations indicated by different observability data requests to determine the appropriate frequency with which to generate the observability data item and the appropriate duration for which to generate the observability data item in order to fulfill the requirements of the different observability data requests.

As an example, three different observability data consumers (U1, U2, and U3) may request the same packet counter representing the number of packets received by a particular user plane function (UPF), but U1 may request the packet counter with a frequency of every minute and for a duration of 25 minutes, U2 may request the packet counter with a frequency of every 30 seconds and for a duration of 5 minutes, and U3 may request the packet counter with a frequency of every 15 seconds and for a duration of 10 minutes. In response, the observability configuration component may generate an observability configuration indicating that the observability data producer is to count the number of packets received by the UPF every 15 seconds for the first 10 minutes (from minute #0 to #10) and then adjust to count the number of packets received by the UPF every minute for the next 15 minutes (from minute #11 to #25).

The observability configuration component may also generate an observability data aggregation model that indicates how to sample the packet counter values to fulfill the requirements of the respective observability data requests. For example, the observability data aggregation model may indicate the following: (1) send the raw packet counter values to U3 from minute #0 to #10; (2) sample every other raw packet counter value and send it to U2 from minute #0 to #5; (3) sample every fourth raw packet counter value and send it to U1 from minute #0 to #10; and (4) send the raw packet counter values to U1 from minute #11 to #25 (because starting at minute #11, the observability data producer is configured to generate a packet counter value every minute).

In the case that the observability data producer has already been configured to generate a particular observability data item with a particular frequency and/or for a particular duration, the observability configuration component may take this existing configuration into consideration to determine the proper configuration that will satisfy both the existing requirements and the requirements of the new observability data requests. If a new observability data consumer submits an observability data request that adds new requirements, then the observability configuration component may dynamically update/adjust the observability configuration and/or the observability data aggregation model to accommodate the new requirements. For example, if a new observability data consumer, U4, requests the packet counter with a frequency of every minute and for a duration of 50 minutes, then the observability configuration component may update the observability configuration to indicate that the observability data producer is to count the number of packets received by the UPF every minute from minute #26 to #50 and update the observability data aggregation model to indicate that the raw packet counter values are to be sent to U4 during this time.

In cases where the observability configuration component determines that it is not possible to fulfill the requirements of the observability requests submitted by the observability data consumers (e.g., after considering the reported capabilities of the observability data producers), the observability configuration component may send messages to certain observability data consumers indicating which of the requested observability data can be provided and which cannot be provided.

At operation 240, observability configuration component configures one or more observability data producers in accordance with the observability configuration to cause the one or more observability data producers to generate observability data. To support efficient and low-overhead observability data generation and sending, the observability data producers may be designed in a way that observability related functionalities can be dynamically configured and/or activated. Thus, when the observability configuration component generates a new observability configuration, it may reconfigure the relevant observability data producers accordingly.

As an example, the observability configuration component may configure network functions in a mobile network (which may be observability data producers) by creating measurement jobs in Performance Management (PM) services (e.g., as specified by 3GPP standards) to cause the relevant network functions to generate measurements that are needed to fulfill the requirements of the observability data requests.

At operation 250, observability data aggregation component collects the observability data generated by the one or more observability data producers.

At operation 260, observability data aggregation component aggregates the collected observability data in accordance with the observability data aggregation model to generate aggregation results for the respective observability data requests. As mentioned above, the observability configuration component generates an observability configuration and observability data aggregation model based on collating observability data requests submitted by multiple different observability data consumers and configures observability data producers in accordance with the observability configuration. The observability data aggregation component may perform what can be viewed as the reverse/corollary operations. For example, in the case that an observability data consumer requested a lower frequency of observability data than being generated by an observability data producer, the observability data aggregation component may sample the observability data generated by the observability data producer to fulfill the requirements of the observability data request. As another example, in the case that multiple observability data items are needed to fulfill the (coarser-grained) requirements of an observability data request, the observability data aggregation component may aggregate the relevant observability data items by combining/processing them before reporting the aggregation result to the observability data consumer.

As an example, if the observability data being requested is the packet delay of a data path within a mobile network, the delays between each hop of the data path may be collected and combined (e.g., summed) to generate the overall packet delay. For each relevant observability data request submitted by the observability data consumers, the observability data aggregation component may aggregate the collected observability data in accordance with the observability data aggregation model to fulfill the requirements of the respective observability data requests. An advantage with this approach is that commonly needed aggregation operations on the same observability data may be performed once (avoiding duplicate processing) and the aggregation results may be shared and reported to each relevant observability data consumer.

As an example, the observability data aggregation component may act as a Management Service (MnS) consumer that collects measurements generated by network functions and aggregates the collected measurements in accordance with the observability data aggregation model before reporting the aggregation results to the respective observability data consumers.

At operation 270, the observability data aggregation component reports, to each of the observability data consumers, the aggregation results for the observability data request submitted by that observability data consumer. The observability data aggregation component may send the aggregation results directly to the observability data consumers and/or store the aggregation results at a storage location accessible by the observability data consumers (e.g., as a file).

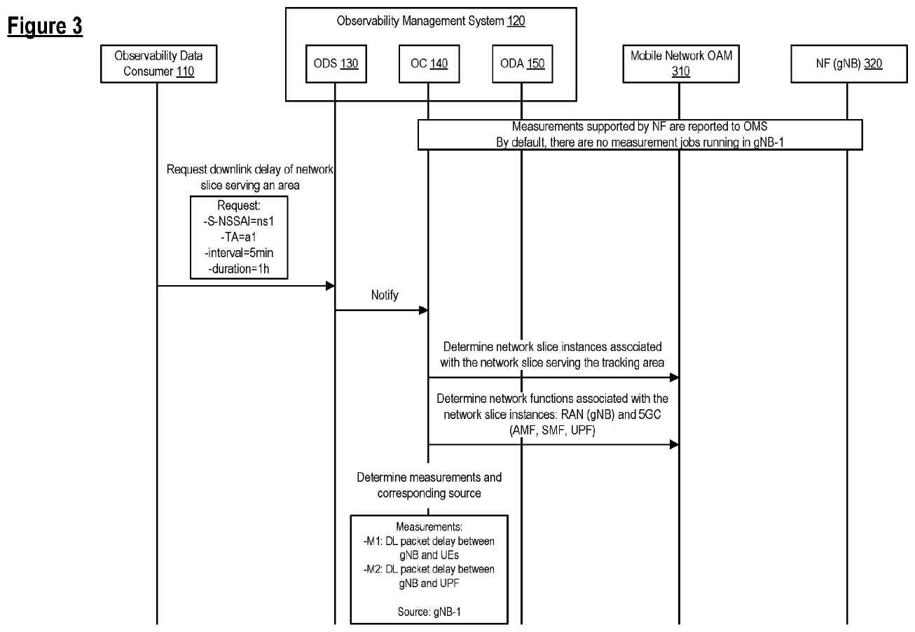

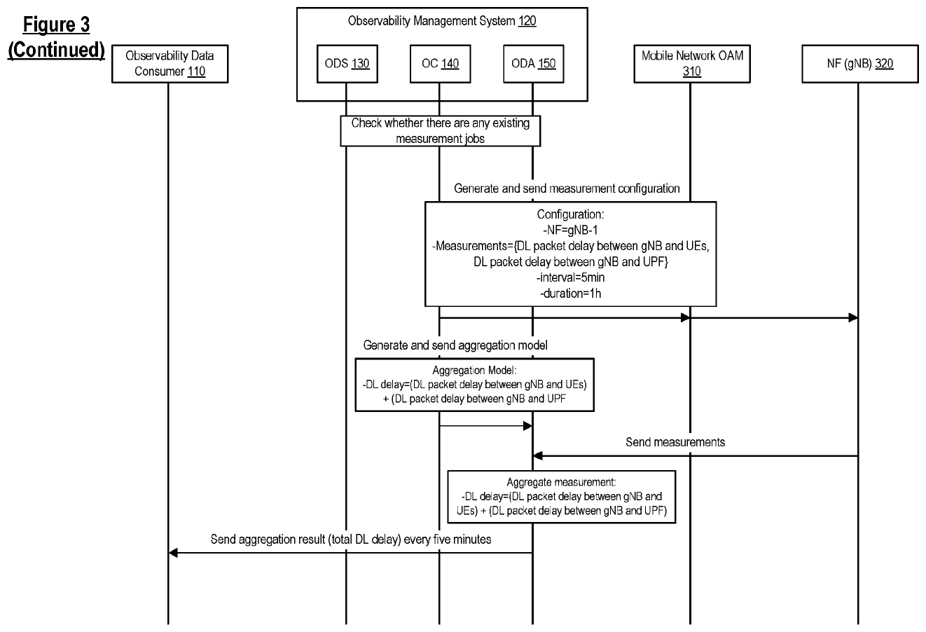

FIG. 3 is a diagram showing component interactions for generating and collecting observability data in a coordinated way, according to some embodiments.

As shown in the diagram, a network function 320, which in this example is a gNB, may report the measurements it supports (e.g., report the list of measurements that the gNB is capable of generating) to the observability configuration component 140.

An observability data consumer 110, which may be, for example, a network automation system, may send an observability data request to the observability data subscription component 130 (“ODS”) to request the downlink delay of 5G connectivity experienced by a certain group of UEs (user equipment) in a given area (e.g., to determine whether 5G cells need to be enabled/disabled, resource allocation in a gNB should be adjusted, and/or the throughput configuration of relevant UPFs should be adjusted—for quality assurance).

The observability data request may include the following information:

{
Targets: 5G connectivity with network slice ns# in area a#
Measurements: Delay
Interval: 5 minutes
Duration: 1 hour
Reporting type: streaming
}

In the above information, “ns #” refers to the Single-Network Slice Selection Assistance Information (S-NSSAI) associated with a particular network slice serving the UEs and “a #” is an identifier of a specific Tracking Area (TA) known to the mobile network management system.

The observability data subscription component 130 may notify the observability configuration component 140 (“OC”) of this request. The observability configuration component 140 may consult the mobile network OAM 310 to determine the network slice instances associated with the specified network slice (“ns1”) serving the specified tracking area (“a1”) and determine the network functions associated with those network slice instances (e.g., RAN network functions (e.g., gNB) and 5G Core (5GC) network functions (e.g., AMF, SMF, UPF)).

The observability configuration component 140 may determine the measurements that are needed to fulfill the requirements of the observability data request and the corresponding observability data producer that can generate the measurements. In this example, the observability configuration component 140 determines that the measurements that are needed are (1) M1: the downlink packet delay between the gNB 320 and UEs (e.g., DRB.DelayDlNgranUeDist.SNSSAI as defined by 3GPP standards); and (2) M2: the downlink packet delay between the gNB 320 and the UPFs (e.g., GTP.DelayDlPsaUpfNgranMean.SNSSAI as defined by 3GPP standards). Also, in this example, the observability configuration component 140 determines that the gNB 320 (e.g., which has an ID of “gNB-1” and is part of the network slice “ns1”) can generate both of these measurements (gNB 320 is the source). The gNB 320 may have previously reported that it is capable of generating such delay measurements.

The observability configuration component 140 may determine whether there are any existing measurement jobs being executed by the gNB 320 (e.g., by checking a configuration list maintained by the observability management system 120 or executing operation listMeasurementJobs (as defined by 3GPP standards) to query the existing measurement jobs being executed by the gNB 320). In this example, it is assumed that there are no existing measurement jobs being executed by the gNB 320.

The observability configuration component 140 may generate and send a measurement configuration to the mobile network OAM 310 to cause the gNB 320 to generate the delay measurements. For example, the measurement configuration may indicate that the target network function is the gNB 320, the measurements to be generated are the downlink packet delay between the gNB 320 and UEs and the downlink packet delay between the gNB 320 and a UPF, the measurement interval is five minutes, and the measurement duration is one hour. The measurement configuration may be represented as shown in Table I below (representing two “createMeasurementJob” for the two delay measurements, M1 and M2, respectively). The mobile network OAM 310 may activate the measurement data generation in the gNB 320 in accordance with the measurement configuration. Various examples provided herein (e.g., Table I and Table II) use terminology adopted from 3GPP standards. It should be appreciated, however, that embodiments are not limited to being used with 3GPP standards.

TABLE I

| iOCInstanceList | gNB-1 |
|---|---|
| measurementCategoryList | M1: DRB.DelayDlNgranUeDist.SNSSAI |
| | M2: GTP.DelayDlPsaUpfNgranMean.SNSSAI |
| | Note: it should specify for the relevant network slices |
| | associated with ‘ns#’ |
| reportingMethod | Streaming |
| granularityPeriod | 5 min |
| startTime | T1 |
| stopTime | T1 + 1 hour |
| streamTarget | Stream endpoint of ODA if aggregation is needed; |
| | otherwise directly the stream endpoint specified by the |
| | observability data consumer/client |

The observability configuration component 140 may generate and send an observability data aggregation model to the observability data aggregation component 150 (“ODA”). In this example, the observability data aggregation data model indicates that the total delay is the sum of the downlink packet delay between the gNB 320 and the UEs and the downlink packet delay between the gNB 320 and the UPF (i.e., M1+M2).

The gNB 320 may generate and send the two delay measurements (i.e., M1 and M2) to the observability data aggregation component 150 per its configuration. The observability data aggregation component 150 may collect the delay measurements from the gNB 320 (or an OAM component that can provide these delay measurements generated by the gNB 320). The observability data aggregation component 150 may aggregate the two delay measurements by calculating the sum of the two delay measurements (i.e., calculating M1+M2 as indicated by the observability data aggregation model). The observability data aggregation component 150 may send the aggregation results (which is the total downlink delay) to the observability data consumer 110 (and do so every five minutes).

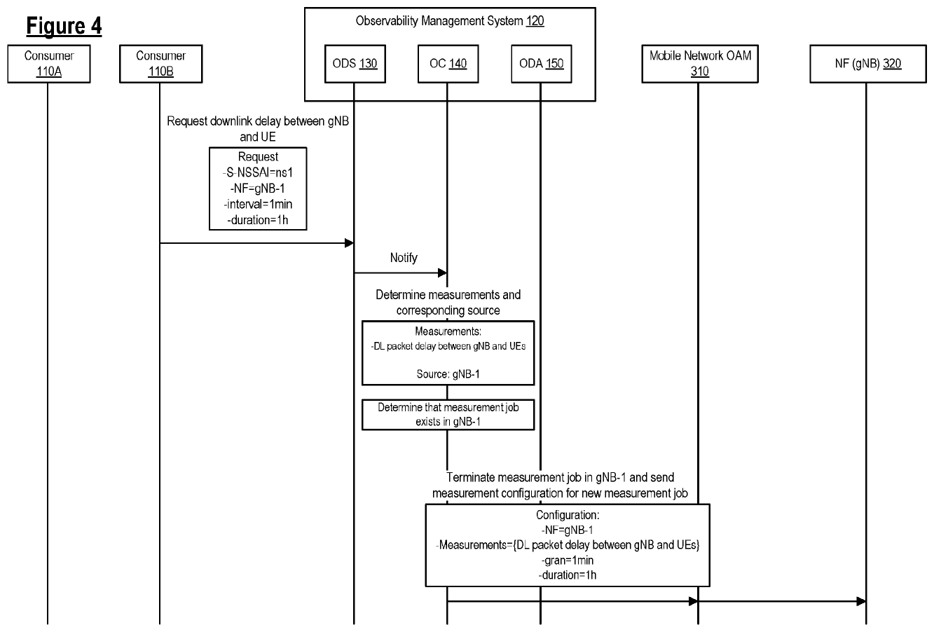

FIG. 4 is a diagram showing component interactions for updating an observability configuration and observability data aggregation model, according to some embodiments. The example shown in the diagram is a continuation of the example shown in FIG. 3 and described above.

In the example shown in the diagram, another observability data consumer 1101B, which may be, for example, a network performance KPI reporting system, may send an observability data request to the observability data subscription component 130 to request the downlink delay measurements between UEs and the gNB 320 (having an ID of “gNB-1”) concerning the same network slice (“ns1”) as in the example shown in FIG. 3. The requested measurement interval is one minute and the requested measurement duration is one hour. Observability data consumer 110A shown in the diagram may correspond to the observability data consumer 110 mentioned above with regard to the example shown in FIG. 3.

The observability data request may include the following information:

{
Targets: network slice “ns1” served by gNB “gNB-1”
Measurements: downlink delay between UEs and gNB
Interval: 1 minute
Duration: 1 hour
Reporting type: streaming
}

The observability data subscription component 130 may notify the observability configuration component 140 of this request. The observability configuration component 140 may determine the measurements that are needed to fulfill the requirements of the observability data request and the corresponding observability data producer that can generate the measurements. In this example, the observability configuration component 140 determines that the measurement that is needed is the downlink packet delay between the gNB 320 and UEs and that the gNB 320 can generate this measurement (gNB 320 is the source).

The observability configuration component 140 may determine whether there are any existing measurement jobs being executed by the gNB 320. In this example, the observability configuration component 140 determines that a measurement job for measuring the downlink packet delay between the gNB 320 and UEs is already being executed by the gNB 320, but with an interval of 5 minutes.

The observability configuration component 140 may cause the existing measurement job being exited by gNB 320 to be terminated (e.g., using “stopMeasurementJob” as defined by 3GPP standards) and generate and send a new measurement configuration to the mobile network OAM 310 to cause the gNB 320 to generate the appropriate delay measurement (e.g., using “createMeasurementJob” as defined by 3GPP standards). For example, the measurement configuration may indicate that the target network function is the gNB 320, the measurements to be generated is the downlink packet delay between the gNB 320 and UEs, the measurement interval is one minute, and the measurement duration is one hour. The measurement configuration may be represented as shown in table II below (representing a “createMeasurementJob” for the delay measurement M1). The mobile network OAM 310 may activate the measurement data generation in the gNB 320 in accordance with the measurement configuration.

TABLE II

| iOCInstanceList | gNB-1 |
|---|---|
| measurementCategoryList | M1: DRB.DelayDlNgranUeDist.SNSSAI |
| | Note: it should specify for the relevant |
| | network slices associated with ‘ns#’ |
| granularityPeriod | 1 min (which is the collated interval of all |
| | the relevant requests) |
| streamTarget | Stream endpoint of ODA |

It should be noted that if there are multiple requests for measurements related to the same network function, the interval may be determined based on collating the multiple measurement requests.

The observability configuration component 140 may update the existing observability data aggregation model and send it to the observability data aggregation component 150. In this example, the updated observability data aggregation model indicates: (1) for observability data consumer 110A, sample every five measurements of the downlink packet delay between the gNB 320 and UEs and sum it with the downlink packet delay between the gNB 320 and the UPF (e.g., sum “DRB.DelayDlNgranUeDist.SNSSAI” and “GTP.DelayDlPsaUpfNgranMean.SNSSAI”); and (2) for observability data consumer 1101B, provide the downlink packet delay between the gNB 320 and UEs (e.g., stream the raw data of “DRB.DelayDlNgranUeDist.SNSSAI”).

The gNB 320 may generate and send the delay measurements (updated version of M1 and M2) to the observability data aggregation component 150 per its updated configuration. The observability data aggregation component 150 may collect the delay measurements from the gNB 320 (or an OAM component that can provide the delay measurements generated by the gNB 320) (e.g., collect the measurement data of updated M1 (generated every 1 minute) and M2 (generated every 5 minutes) from the gNB 320). The observability data aggregation component 150 may aggregate measurement data for observability data consumer 110A and observability data consumer 110B in accordance with the observability data aggregation model. For example, for observability data consumer 110A, the observability data aggregation component 150 may aggregate the two delay measurements by sampling every five measurements of the downlink delay between the gNB 320 and UEs and summing it with the downlink delay between the gNB 320 and the UPF (e.g., sample every 5 measurements of “DRB.DelayDlNgranUeDist.SNSSAI” and sum it with “GTP.DelayDlPsaUpfNgranMean.SNSSAI”). For observability data consumer 1101B, the observability data aggregation component 150 may just extract the downlink delay between the gNB 320 and UEs without having to sample or combine it with other measurements (e.g., take every measurement of “DRB.DelayDlNgranUeDist.SNSSAI”). The observability data aggregation component 150 may send the aggregation results to the respective observability data consumers 110 (e.g., do so every five minutes for observability data consumer 110A and every minute for observability data consumer 1101B).

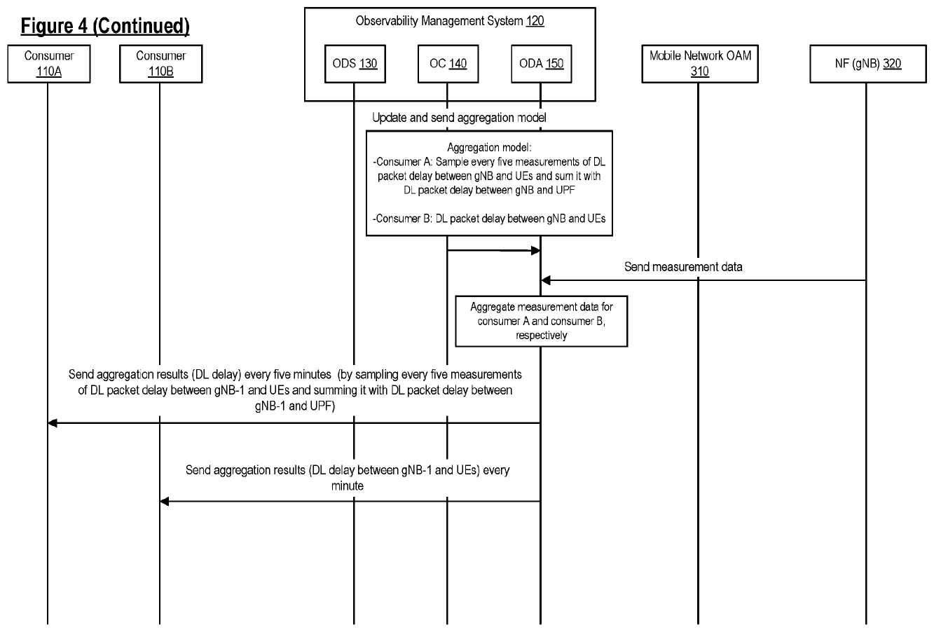

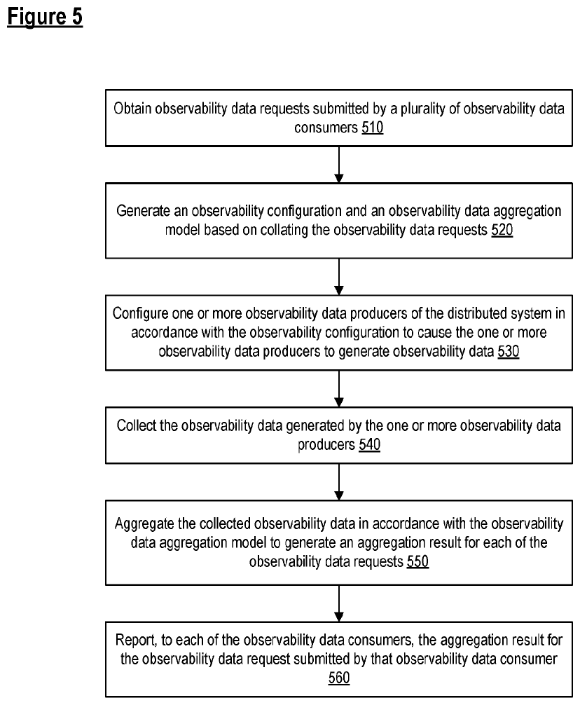

FIG. 5 is a flow diagram of a method for collecting observability data regarding a distributed system, according to some embodiments. In an embodiment, the method is performed by an observability management system implemented by one or more computing devices. In an embodiment, the distributed system is a mobile network.

At operation 510, the observability management system obtains observability data requests submitted by a plurality of observability data consumers. In an embodiment, an observability data request indicates one or more of: one or more targets to observe/monitor, one or more types of observability data to collect, an observability data collection frequency, an observability data collection duration, and observability data reporting instructions.

At operation 520, the observability management system generates an observability configuration and an observability data aggregation model based on collating the observability data requests. In an embodiment, the collating includes translating observability data requirements of the observability data requests submitted by the plurality of observability data consumers to lower-level observability data requirements and determining whether there is overlap in the lower-level observability data requirements.

In an embodiment, the observability management system receives an observability capability report from at least one of the one or more observability data producers, wherein the observability capability report indicates which types of observability data the at least one of the one or more observability data producer is capable of generating. The observability management system may take the information included in the observability capability report into consideration when generating the observability configuration.

At operation 530, the observability management system configures one or more observability data producers of the distributed system in accordance with the observability configuration to cause the one or more observability data producers to generate observability data. In an embodiment, the configuring includes configuring a particular one of the one or more observability data producers to execute a single job that generates observability data that can be used to fulfill requirements of more than one of the observability data requests. In an embodiment, the particular one of the observability data producers is configured to generate observability data with a frequency and duration that are determined based on collating frequencies and durations indicated by the more than one of the observability data requests.

At operation 540, the observability management system collects the observability data generated by the one or more observability data producers. In an embodiment, the collected observability data includes one or more of: logs, metrics, and traces.

At operation 550, the observability management system aggregates the collected observability data in accordance with the observability data aggregation model to generate an aggregation result for each of the observability data requests. In an embodiment, the aggregating includes one or more of: sampling observability data items (e.g., particular measurements) from the collected observability data and combining observability data items from the collected observability data.

At operation 560, the observability management system reports, to each of the observability data consumers, the aggregation result for the observability data request submitted by that observability data consumer.

Embodiments can be used in a mobile network context to fulfill the requirement of coordinating management data production defined by 3GPP standards. For example, components of Open Network Authentication Platform (ONAP) (which is a popular open-source project of network management system) such as DMaaP (Data Movement as a Platform) and/or DCAE (Data Collection Analytics and Events) may be extended by implementing techniques described herein. More specifically, observability data consumers (e.g., VES consumer and/or File consumer) may submit observability data requests for network measurement data from DMaaP to an observability data subscription component. The observability configuration component may consolidate and collate the different observability data requests, generate the appropriate measurement jobs (e.g., “PerfMetricJob” with the proper parameters (e.g., interval)), and configure the relevant network functions and 3GPP PM Mapper accordingly. The observability configuration component may also generate an observability data aggregation model and send it to the observability data aggregation component. The observability data aggregation component may collect the measurement data generated by the network functions, aggregate the collected measurement data, and send the aggregation results to the observability data consumers (e.g., VES consumer and/or File consumer). Embodiments may be realized as a set of microservices deployed/distributed in a cloud environment.

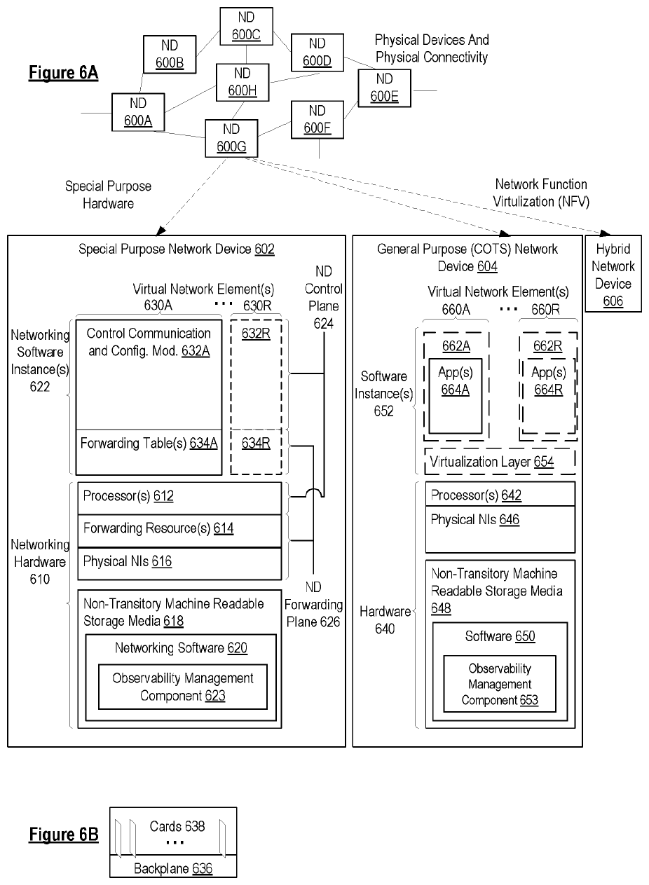

FIG. 6A illustrates connectivity between network devices (NDs) within an exemplary network, as well as three exemplary implementations of the NDs, according to some embodiments of the invention. FIG. 6A shows NDs 600A-H, and their connectivity by way of lines between 600A-600B, 600B-600C, 600C-600D, 600D-600E, 600E-600F, 600F-600G, and 600A-600G, as well as between 600H and each of 600A, 600C, 600D, and 600G. These NDs are physical devices, and the connectivity between these NDs can be wireless or wired (often referred to as a link). An additional line extending from NDs 600A, 600E, and 600F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated-circuits (ASICs) and a special-purpose operating system (OS); and 2) a general purpose network device 604 that uses common off-the-shelf (COTS) processors and a standard OS.

The special-purpose network device 602 includes networking hardware 610 comprising a set of one or more processor(s) 612, forwarding resource(s) 614 (which typically include one or more ASICs and/or network processors), and physical network interfaces (NIs) 616 (through which network connections are made, such as those shown by the connectivity between NDs 600A-H), as well as non-transitory machine readable storage media 618 having stored therein networking software 620. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A).

The special-purpose network device 602 is often physically and/or logically considered to include: 1) a ND control plane 624 (sometimes referred to as a control plane) comprising the processor(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the processor(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

In an embodiment, software 620 includes code such as observability management component 623, which when executed by networking hardware 610, causes the special-purpose network device 602 to perform operations of one or more embodiments disclosed herein (e.g., for generating and collecting observability data related to a distributed system).

FIG. 6B illustrates an exemplary way to implement the special-purpose network device 602 according to some embodiments of the invention. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general purpose network device 604 includes hardware 640 comprising a set of one or more processor(s) 642 (which are often COTS processors) and physical NIs 646, as well as non-transitory machine readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization. For example, in one such alternative embodiment the virtualization layer 654 represents the kernel of an operating system (or a shim executing on a base operating system) that allows for the creation of multiple instances 662A-R called software containers that may each be used to execute one (or more) of the sets of applications 664A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 654 represents a hypervisor (sometimes referred to as a virtual machine monitor (VMM)) or a hypervisor executing on top of a host operating system, and each of the sets of applications 664A-R is run on top of a guest operating system within an instance 662A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels and sets of applications that are run in different software containers).

The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual network element(s) 660A-R.

The virtual network element(s) 660A-R perform similar functionality to the virtual network element(s) 630A-R—e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 662A-R to VNEs also apply to embodiments where such a finer level of granularity and/or unikernels are used.

In certain embodiments, the virtualization layer 654 includes a virtual switch that provides similar forwarding services as a physical Ethernet switch. Specifically, this virtual switch forwards traffic between instances 662A-R and the physical NI(s) 646, as well as optionally between the instances 662A-R; in addition, this virtual switch may enforce network isolation between the VNEs 660A-R that by policy are not permitted to communicate with each other (e.g., by honoring virtual local area networks (VLANs)).

In an embodiment, software 650 includes code such as observability management component 653, which when executed by hardware 640, causes the general purpose network device 604 to perform operations of one or more embodiments disclosed herein (e.g., for generating and collecting observability data related to a distributed system).

The third exemplary ND implementation in FIG. 6A is a hybrid network device 606, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto without departing from the broader spirit and scope of the disclosure provided herein. The specification and drawings are, accordingly, to be regarded in an illustrative sense rather than a restrictive sense.

1. A method performed by an observability management system implemented by one or more computing devices to collect observability data regarding a distributed system, the method comprising:
obtaining observability data requests submitted by a plurality of observability data consumers;
generating an observability configuration and an observability data aggregation model based on collating the observability data requests;
configuring one or more observability data producers of the distributed system in accordance with the observability configuration to cause the one or more observability data producers to generate observability data;
collecting the observability data generated by the one or more observability data producers;
aggregating the collected observability data in accordance with the observability data aggregation model to generate an aggregation result for each of the observability data requests, wherein the aggregating includes sampling observability data items from the collected observability data to generate the aggregation result for one of the observability data requests and extracting observability data items from the collected observability data without sampling to generate the aggregation result for another one of the observability data requests; and
reporting, to each of the plurality of observability data consumers, the aggregation result for the observability data request submitted by the observability data consumer.

2. The method of claim 1, wherein the collected observability data includes one or more of: logs, metrics, and traces.

3. The method of claim 1, further comprising:
receiving an observability capability report from at least one of the one or more observability data producers, wherein the observability capability report indicates which types of observability data the at least one of the one or more observability data producer is capable of generating.

4. The method of claim 1, wherein an observability data request indicates one or more of: one or more targets to observe, one or more types of observability data to collect, an observability data collection frequency, an observability data collection duration, and observability data reporting instructions.

5. The method of claim 1, wherein the collating includes translating observability data requirements of the observability data requests submitted by the plurality of observability data consumers to lower-level observability data requirements and determining whether there is overlap in the lower-level observability data requirements.

6. The method of claim 1, wherein the configuring includes configuring a particular one of the one or more observability data producers to execute a single job that generates observability data that can be used to fulfill requirements of more than one of the observability data requests.

7. The method of claim 6, wherein the particular one of the observability data producers is configured to generate observability data with a frequency and duration that are determined based on collating frequencies and durations indicated by the more than one of the observability data requests.

8. The method of claim 1, wherein the aggregating further includes combining observability data items from the collected observability data.

9. The method of claim 1, wherein the distributed system is a mobile network.

10. A non-transitory machine-readable medium comprising computer program code, which when executed by one or more computing devices, causes the one or more computing devices to perform operations for collecting observability data regarding a distributed system, the operations comprising:
obtaining observability data requests submitted by a plurality of observability data consumers;
generating an observability configuration and an observability data aggregation model based on collating the observability data requests;
configuring one or more observability data producers of the distributed system in accordance with the observability configuration to cause the one or more observability data producers to generate observability data;
collecting the observability data generated by the one or more observability data producers;
aggregating the collected observability data in accordance with the observability data aggregation model to generate an aggregation result for each of the observability data requests, wherein the aggregating includes sampling observability data items from the collected observability data to generate the aggregation result for one of the observability data requests and extracting observability data items from the collected observability data without sampling to generate the aggregation result for another one of the observability data requests; and
reporting, to each of the plurality of observability data consumers, the aggregation result for the observability data request submitted by the observability data consumer.

11. The non-transitory machine-readable medium of claim 10, wherein the collected observability data includes one or more of: logs, metrics, and traces.

12. The non-transitory machine-readable medium of claim 10, wherein the operations further comprise:
receiving an observability capability report from at least one of the one or more observability data producers, wherein the observability capability report indicates which types of observability data the at least one of the one or more observability data producer is capable of generating.

13. The non-transitory machine-readable medium of claim 10, wherein an observability data request indicates one or more of: one or more targets to observe, one or more types of observability data to collect, an observability data collection frequency, an observability data collection duration, and observability data reporting instructions.

14. The non-transitory machine-readable medium of claim 10, wherein the collating includes translating observability data requirements of the observability data requests submitted by the plurality of observability data consumers to lower-level observability data requirements and determining whether there is overlap in the lower-level observability data requirements.

15. The non-transitory machine-readable medium of claim 10, wherein the configuring includes configuring a particular one of the one or more observability data producers to execute a single job that generates observability data that can be used to fulfill requirements of more than one of the observability data requests.

16. The non-transitory machine-readable medium of claim 15, wherein the particular one of the observability data producers is configured to generate observability data with a frequency and duration that are determined based on collating frequencies and durations indicated by the more than one of the observability data requests.

17. The non-transitory machine-readable medium of claim 10, wherein the aggregating further includes combining observability data items from the collected observability data.

18. The non-transitory machine-readable medium of claim 10, wherein the distributed system is a mobile network.

19. A computing device comprising:
one or more processors; and
a non-transitory machine-readable storage medium storing computer instructions that, if executed by the one or more processors, causes the computing device to:
obtain observability data requests submitted by a plurality of observability data consumers;
generate an observability configuration and an observability data aggregation model based on collating the observability data requests;
configure one or more observability data producers of a distributed system in accordance with the observability configuration to cause the one or more observability data producers to generate observability data;
collect the observability data generated by the one or more observability data producers;
aggregate the collected observability data in accordance with the observability data aggregation model to generate an aggregation result for each of the observability data requests, wherein the aggregating of the collected observability data includes sampling observability data items from the collected observability data to generate the aggregation result for one of the observability data requests and extracting observability data items from the collected observability data without sampling to generate the aggregation result for another one of the observability data requests; and
report, to each of the plurality of observability data consumers, the aggregation result for the observability data request submitted by the observability data consumer.

20. The computing device of claim 19, wherein the configuring of the one or more observability data producers includes configuring a particular one of the one or more observability data producers to execute a single job that generates observability data that can be used to fulfill requirements of more than one of the observability data requests.
